(19) United States
(12) Patent Application Publication
(10) Pub. No.: US 2013/0031583 A1
(43) Pub. Date: Jan. 31, 2013

(54) ELECTRONIC APPARATUS, CONTROL METHOD OF ELECTRONIC APPARATUS AND NON-TRANSITORY COMPUTER-READABLE MEDIUM STORING COMPUTER EXECUTABLE CONTROL PROGRAM OF ELECTRONIC APPARATUS

(71) Applicant: Keisuke Morohashi, Hinjo-shi (JP)

(72) Inventor: Keisuke Morohashi, Hinjo-shi (JP)

(21) Appl. No.: 13/440,286

(22) Filed: Apr. 5, 2012

(30) Foreign Application Priority Data
Jul. 28, 2011 (JP) 2011-166088

(51) Int. Cl. H04N 21/482

(52) U.S. Cl. 725/40

(57) ABSTRACT

According to one embodiment, an electronic apparatus includes: an output instructing module which instructs a server, stored therein electronic program table information, to output the electronic program table information; a receiver which receives the electronic program table information and program related information output from the server; and an electronic program table output module which uses the received electronic program table information and program related information to output an electronic program table being attached with the program related information.

### CROSS REFERENCE TO RELATED APPLICATION(S)

The application is based upon and claims the benefit of priority from Japanese Patent Application No. 2011-166088 filed on Jul. 28, 2011; the entire contents of which are incorporated herein by reference.

### FIELD

Embodiments described herein relate generally to an electronic apparatus, an electronic apparatus control method and a non-transitory computer-readable medium storing a computer executable control program of the electronic apparatus.

### BACKGROUND

In recent years, electronic apparatuses, such as televisions, for receiving and displaying broadcast programs have been increasingly popular. Such electronic apparatuses can display an electronic program table including a plurality of broadcast programs and allow a user to select and designate a desired broadcast program from the electronic program table.

However, for example, as the number of programs included in the electronic program table is increasing in the electronic apparatuses, users may have difficulty in selecting and designating desired programs from the electronic program table.

Accordingly, there is a need to provide users with information necessary for selecting and designating of programs from the electronic program table.

### BRIEF DESCRIPTION OF THE DRAWINGS

Exemplary embodiments of the present invention will be described in detail based on the following figures, wherein:

FIG. 1 is a block diagram illustrating a configuration of an electronic apparatus according to an embodiment;

FIGS. 2A and 2B are views illustrating an electronic program table displayed on a display module of the electronic apparatus according to the embodiment;

FIGS. 3A and 3B are views illustrating another electronic program table displayed on a display module of the electronic apparatus according to the embodiment;

FIG. 4 is a flow chart illustrating a process in which the electronic apparatus according to the embodiment accesses a connected server, a user writes program related information (e.g., user comments) for a particular program, and the program related information is stored in the server;

FIG. 5 is a flow chart illustrating a process in which the electronic apparatus according to the embodiment receives and displays electronic program table information attached with the program related information; and

FIG. 6 is a view illustrating an external appearance of an electronic apparatus according to another embodiment.

### DETAILED DESCRIPTION OF THE EXEMPLARY EMBODIMENTS

According to one embodiment, an electronic apparatus includes: an output instructing module which instructs a server, stored therein electronic program table information, to output the electronic program table information; a receiver which receives the electronic program table information and program related information output from the server; and an electronic program table output module which uses the received electronic program table information and program related information to output an electronic program table being attached with the program related information.

Hereinafter, embodiments will be described with reference to the drawings.

The embodiments will be described using a television as an electronic apparatus 1.

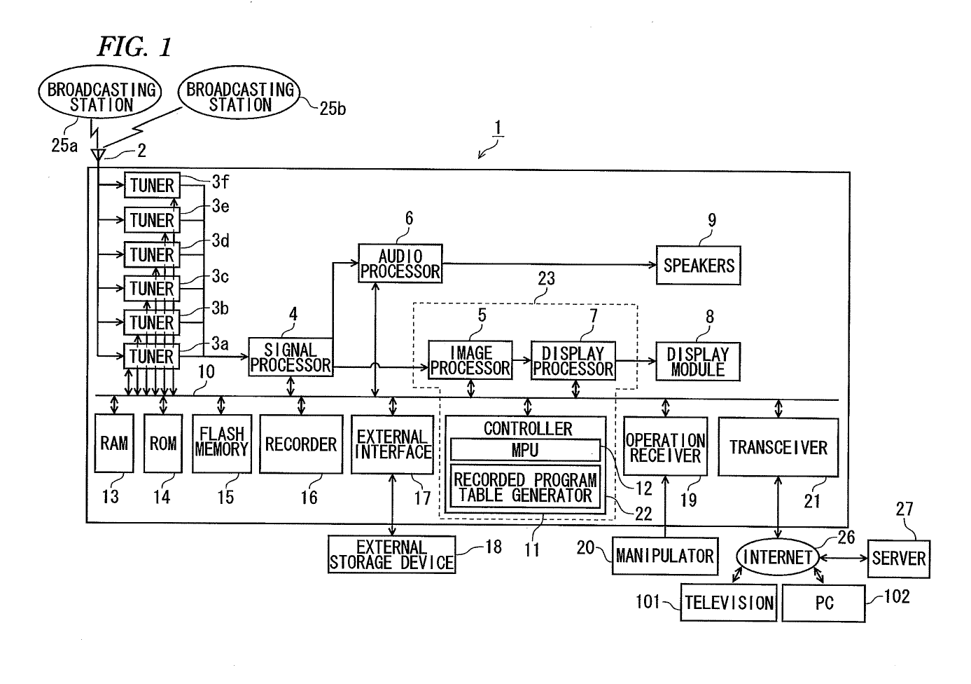

FIG. 1 is a block diagram illustrating a configuration of the electronic apparatus 1 according to an embodiment.

In this embodiment, a plurality of programs are broadcasted from a plurality of broadcasting stations such as broadcasting stations 25a and 25b.

An antenna 2 is connected to the electronic apparatus (television) 1. Reference numerals 3a, 3b, 3c, 3d, 3e and 3f denote a plurality of tuners.

The plurality of programs (broadcast signals) broadcasted in the form of broadcast waves format (BWF) from the plurality of broadcasting stations 25a and 25b are received by the antenna 2 and transmitted to the tuners 3a to 3f. The tuners 3a to 3f select and tune the plurality of programs and output the programs to a signal processor 4.

An MPU 12 of a controller 11 is connected, via a bus 10, to the tuners 3a, 3b, 3c, 3d, 3e and 3f, the signal processor 4, an image processor 5, a audio processor 6, a display processor 7, a RAM 13, a ROM 14, a flash memory 15, a recorder (picture recorder) 16, an external interface 17, a operation receiver 19, a manipulator (remote controller) 20 and a transceiver 21, and controls these components.

The signal processor 4 is tuned by the tuners 3a to 3f, decodes image signals of the plurality of transmitted programs simultaneously (or in parallel), and outputs the decoded image signals to the recorder 16 in the transport stream (TS) format.

The recorder 16 is a mass storage data recorder (image signal storage device) including a recording medium such as HDD or SSD and is contained in the image display apparatus (electronic apparatus) 1.

The recorder 16 receives the image signals transmitted in the transport stream (TS) format continuously and records all of the plurality of received broadcast programs (entire recording).

Upon watching one of the received broadcast programs entirely recorded in recorder 16, a user designates a desired program from a past electronic program table to be described later. An image signal of the designated program is clipped (extracted) from image signals of all of the plurality of recorded broadcast programs and is displayed on a display module 8, thereby allowing the broadcast program to be watched.

A past electronic program table is generated in a recorded program table generator 22 of the controller 11.

The image signal designated by the user and clipped from all of the recorded image signals is decoded in the signal processor 4 to extract and output the audio and image signals. The audio signal is output to the audio processor 6, and the image signal is output to the image processor 5.

The audio processor 6 decodes the output audio signal, and then outputs to speakers 9. The speakers 9 receive the decoded audio signal and convert the audio signal into audio to be output.

The image processor 5 decodes the output image signal, and then outputs to the display processor 7. The display processor 7 performs a display processing on color, display position or the like for the output image signal, and then outputs the processed signal to the display module 8. The display module 8 receives the processed display image signal, and the processed display image signal is then displayed on a display module (not shown) such as a display panel.

The past electronic program table generated in the recording program table generator 22 is displayed on the display module 8, as described above.

In this embodiment, an external storage device 18 including a storage medium such as HDD or SSD is connected to the electronic apparatus 1 via the external interface 17 and may be used similarly as in the recorder 16.

The manipulator 20 such as a remote controller or a keyboard is connected via the operation receiver 19, and thus the electronic apparatus 1 can be operated by the user.

The electronic apparatus 1 is connected to the Internet 26 and can communicate with the Internet 26, via the transceiver 21.

Although it has been described in the above that the tuners 3a to 3f are used for the entire recording, the tuners may be used in PVR recording as well.

In the embodiment, the electronic apparatus 1 is connected to a server 27 via the Internet 26. Likewise, other electronic apparatuses (for example, a television 101, a PC 102) may be connected to the server 27 via the Internet 26 as well.

Information of the electronic program table (electronic program table information) is stored in the server 27.

The electronic program table, also called an electronic program guide (EPG), will be described hereinafter. The electronic program guide is a system for displaying a broadcast program table, in which broadcast programs are arranged in a table format on a television screen as an example.

A user can operate the electronic apparatus 1 or other electronic apparatuses such as, for example, the television 101 and the PC 102, and can transmit program related information to the server 27 via the Internet 26, which will be described later. The server 27 receives the program related information transmitted from the plurality of users and stores the received information in association with the electronic program table information.

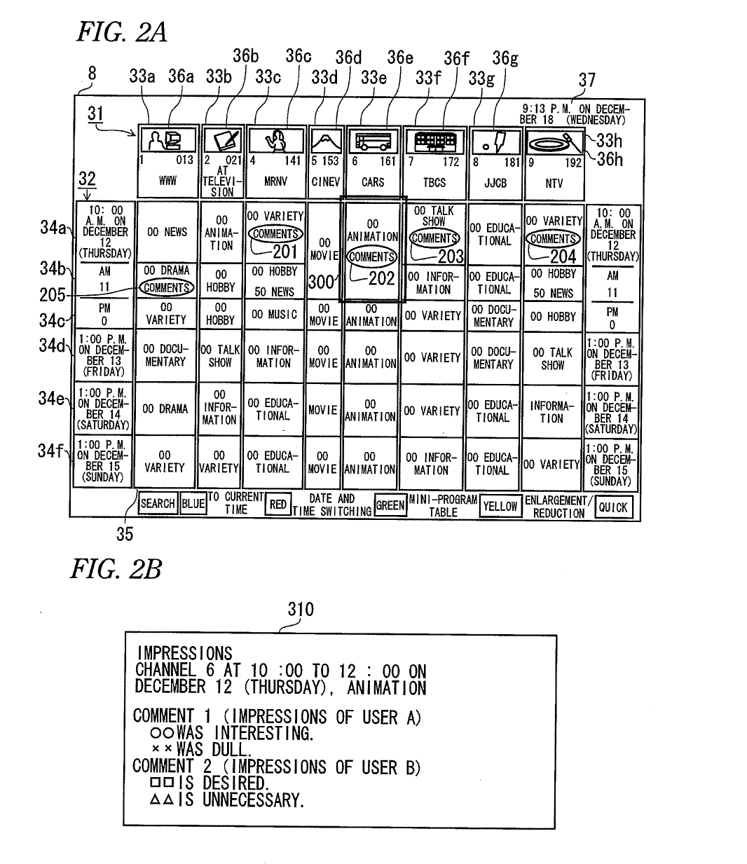

FIGS. 2A and 2B are views illustrating an electronic program table displayed on the display module of the electronic apparatus 1 according to the embodiment.

For example, FIG. 2A shows an electronic program table indicating contents of all of a plurality of recorded broadcast programs. This electronic program table is called a past program table since it is an electronic program table for previously broadcasted programs.

FIG. 2A shows a past program table 35. The past program table 35 can be displayed on the display module 8, for example.

Reference numeral 37 denotes current date and time indicating, for example, 9: 13 P.M. on December 18 (Wednesday).

Reference numeral 32 denotes a date and time section and reference numerals 34a, 34b, 34c, 34d, 34e and 34f denote date and time.

Reference numeral 34a indicates 9: 00 to 10: 00 A.M. on December 12 (Thursday), reference numeral 34b indicates 10: 00 to 11: 00 A.M. on December 12 (Thursday), reference numeral 34c indicates 11: 00 to 0: 00 A.M. on December 12 (Thursday), reference numeral 34d indicates 0: 00 to 1: 00 P.M. on December 13 (Friday), reference numeral 34e indicates 0: 00 to 1: 00 P.M. on December 14 (Saturday), and reference numeral 34f indicates 0: 00 to 1: 00 P.M. on December 15 (Sunday).

Reference numeral 31 denotes a channel section and reference numerals 33a, 33b, 33c, 33d, 33e, 33f, 33g and 33h denote channels. Reference numeral 33a indicates channel ‘WWW’, reference numeral 33b indicates channel ‘At Television’, reference numeral 33c indicates channel ‘MRNV’, reference numeral 33d indicates channel ‘CineV’, reference numeral 33e indicates channel ‘Ccns’, reference numeral 33f indicates channel ‘Tbcs’, reference numeral 33g indicates channel ‘JJCB’, and reference numeral 33h indicates channel ‘NTV’.

Further, these channels perform displaying of moving images for all of the recorded broadcast programs.

Reference numeral 36a, 36b, 36c, 36d, 36e, 36f, 36g and 36h denote moving image displays of the recorded programs.

Reference numeral 36a indicates moving image display of channel ‘WWW’, reference numeral 36b indicates moving image display of channel ‘At Television’, reference numeral 36c indicates moving image display of channel ‘MRNV’, reference numeral 36d indicates moving image display of channel ‘CineV’, reference numeral 36e indicates moving image display of channel ‘Ccns’, reference numeral 36f indicates moving image display of channel ‘Tbcs’, reference numeral 36g indicates moving image display of channel ‘JJCB’, and reference numeral 36h indicates moving picture display of channel ‘NTV’.

For these displays, for example, programs designated by defaults (for example, the top section of each channel of the electronic program table) are displayed.

In this embodiment, program related information (including, for example, users' comments and impressions) is displayed in the electronic program table (the past program table) 35.

Reference numerals 201, 202, 203, 204 and 205 indicate the program related information. As shown in FIG. 2A, these program related information are displayed attached with the electronic program table 35.

Reference numeral 300 denotes a program designated by a user. For example, this designation is performed by moving a cursor with the user's remote controller (not shown) operation. For example, as shown in FIG. 2A, “animation” broadcasted on “Channel 6 at 10: 00 to 12: 00 on December 12 (Thursday)” is designated.

FIG. 2B shows a second display 310 of the program related information that indicates information related to the designated program (“animation” 300) in detail.

As shown in FIG. 2B, for example, program (“animation” 300) related information transmitted from two users (user A and user B) is displayed in the second display 310.

For example, Comment 1, “OO was interesting.” and “XX was dull.” have been displayed as impressions of user A, following “Impression”, “Channel 6 at 10 :00 to 12 : 00 on December 12 (Thursday)” and “animation”.

In addition, as an impression of user B, Comment 2, “□□ is desired.” and “ΔΔ is unnecessary.”, have been displayed.

That is, in this embodiment, both of the displays 201 to 205 of the program related information and the second display 310 indicating the designated program related information in detail can be displayed.

In this embodiment, for example, usefulness of information shared between users can be improved.

Although in the above embodiment the electronic program table has been illustrated with the past program table, this embodiment may be equally applied to a typical electronic program table (including program information of current and future programs), explanation of which will be omitted for the purpose of brevity.

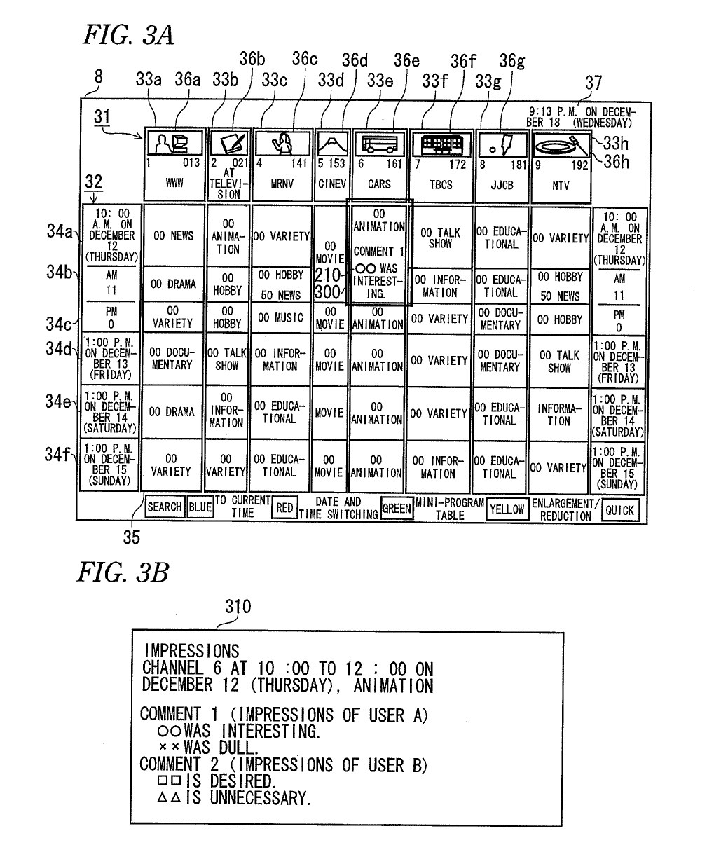

FIGS. 3A and 3B are views illustrating another electronic program table displayed on a display module of the electronic apparatus 1 according to the embodiment.

As shown in FIG. 3A, instead of the displays 201 to 205 of the program related information, a portion of user comments 210 are directly displayed in an electronic program table 35.

Even in this embodiment, as shown in FIG. 3B, it may be configured that second display 310 of the program related information indicating information related to the designated program (“animation” 300) in detail is displayed. The second display 310 may be displayed along with the electronic program table 35.

As well as the configuration described above, for example, program related information (“animation” 300) transmitted from two users (user A and user B) is displayed in the second display 310.

In this embodiment, both of the portions of the user comments 210 and the second display 310 indicating the related information of the designated program in detail can be displayed.

The program-related information may be output in an identifiable manner with a color that indicates a program differing from other programs, instead of the displays 201, 202, 203, 204 and 205 of the program related information or the portion of user comments 210.

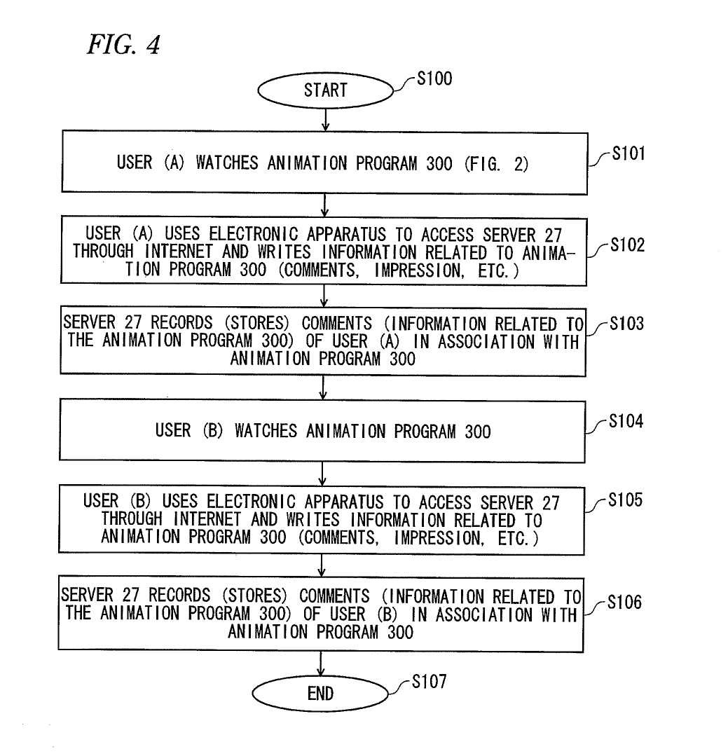

FIG. 4 is a flow chart illustrating a process in which an electronic apparatus according to the embodiment accesses a server connected with the electronic apparatus, and a user writes the above-described program related information for a particular program, and the program related information is stored in the server.

The process starts from step S100, and then the process proceeds to step S101.

At step S101, for example, a user A watches the animation program 300 shown in FIG. 2A. Subsequently, the process proceeds to step S102.

At step S102, the user A uses an electronic apparatus such as a television or a PC to access the server 27 through the Internet and writes information related to the animation program 300 (comments, impressions and so on). Subsequently, the process proceeds to step S103.

At step S103, the server 27 records (stores) the comments (the information related to the animation program 300) of the user A in association with the animation program 300. Subsequently, the process proceeds to step S104.

At step S104, a user B watches the animation 300, and then the process proceeds to step S105.

At step S105, the user B uses an electronic apparatus such as a television or a PC to access the server 27 through Internet and writes information related to the animation program 300 (comments, impressions and so on). Subsequently, the process proceeds to step S106.

At step S106, the server 27 records (stores) the comments of the user B in association with the program (the animation 300). Subsequently, the process proceeds to step S107.

At step S107, the process is ended.

As described above, the program related information transmitted from a plurality of users (user A and user B) is stored in the server 27 in association with the electronic program table 35.

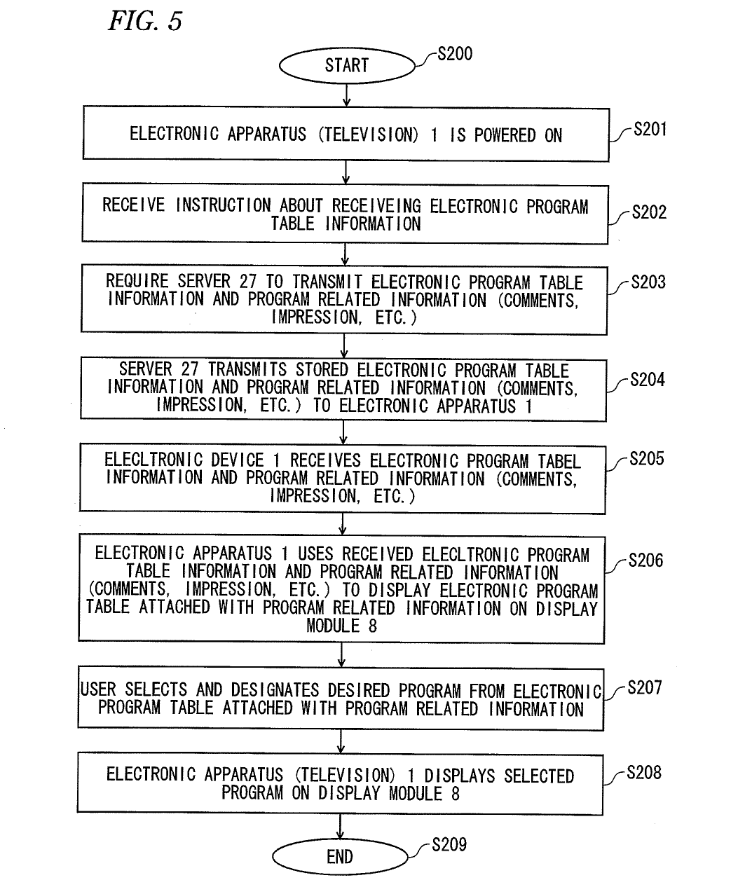

FIG. 5 is a flow chart illustrating a process in which an electronic apparatus according to an embodiment receives and displays electronic program table information attached with program related information.

The process starts from step S200, and then the process proceeds to step S201.

At step S201, an electronic apparatus (television) 1 is powered ON. Subsequently, the process proceeds to step S202.

At step S202, for example, a user operates a remote controller (not shown) to instruct the electronic apparatus 1 to receive the above-described electronic program table information, and the electronic apparatus 1 receives this information. Subsequently, the process proceeds to step S203.

At step S203, the electronic apparatus 1 requires the server 27 to transmit the electronic program table information and the program related information (comments, impressions and so on). Subsequently, the process proceeds to step S204.

At step S204, the server 27 transmits the stored electronic program table information and the program related information to the electronic apparatus 1. Subsequently, the process proceeds to step S205.

At step S205, the electronic apparatus 1 receives the electronic program table information and the program related information that are transmitted from the server 27. Subsequently, the process proceeds to step S206.

At step S206, the electronic apparatus 1 uses the received electronic program table information and the program related information to display an electronic program table attached with the program related information on the display module 8, as shown in FIG. 2 or 3. Subsequently, the process proceeds to step S207.

At step S207, the user selects and designates a desired program from the electronic program table 35 attached with the program related information. Subsequently, the process proceeds to step S208.

At step S208, the electronic apparatus 1 displays the selected program on the display module 8. Subsequently, the process proceeds to step S209.

At step S209, the process is ended.

In this embodiment, the electronic apparatus 1 and the server 27 are connected with each other via the Internet 26. The electronic apparatus 1 instructs the server 27 to output the electronic program table information having stored therein, as described above.

The electronic apparatus 1 receives the electronic program table information and the program related information output from the server 27.

The electronic apparatus 1 uses the received electronic program table information and program related information to output an electronic program table attached with the program related information.

As described above, the program related information includes user comments.

The electronic apparatus 1 instructs the server 27 to output the program related information.

The electronic apparatus 1 displays the output electronic program table attached with the program related information.

The electronic apparatus 1 is configured to designate a desired program from the output electronic program table attached with the program related information.

The electronic apparatus 1 outputs the program related information to the electronic program table in an identifiable manner.

The electronic apparatus 1 is configured to display the second display to output the program related information.

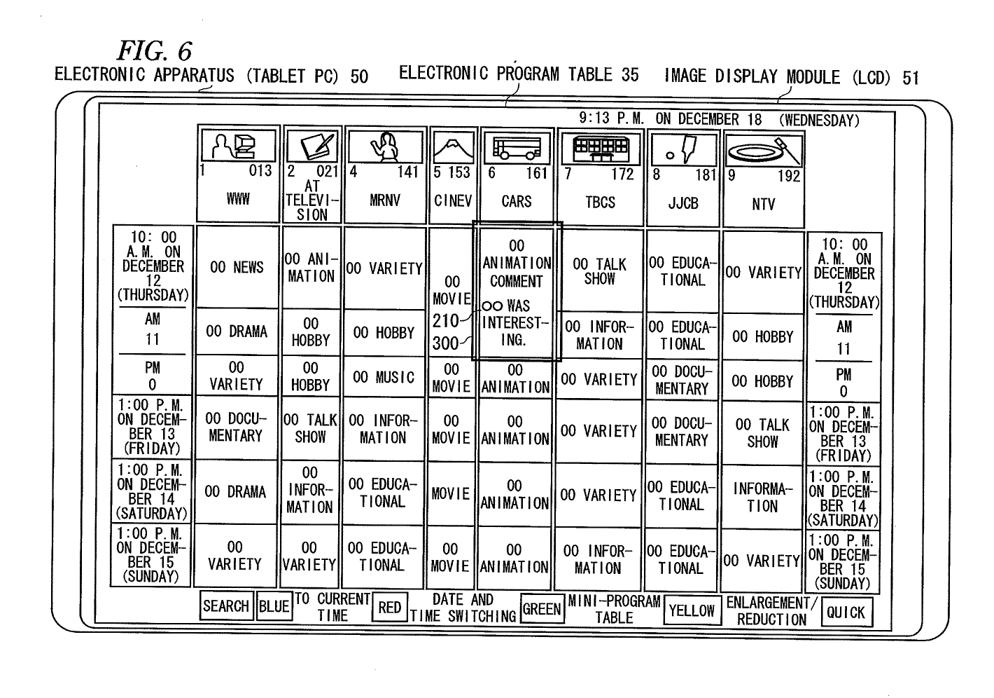

FIG. 6 is a view illustrating an external appearance of an electronic apparatus according to another embodiment.

In this embodiment, a tablet PC is used for an electronic apparatus 50.

For example, the electronic program table 35 attached with the program related information (comments, impressions and so on) is displayed on an image display module (LCD) 51 of the electronic apparatus 50, as in FIG. 2A.

In this embodiment, the above-described configuration makes it possible to provide users with materials for decision on designation of programs from an electronic program table.

The procedure of control process of the above embodiments may be executed by software. Accordingly, the same effects as the above embodiments can be easily achieved only by installing the procedure of control process into a common computer and executing it by utilizing a computer readable storage medium.

While certain exemplary embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
an output instructing module configured to instruct a server, stored therein electronic program table information, to output the electronic program table information;
a receiver configured to receive the electronic program table information and program related information output from the server; and
an electronic program table output module configured to use the received electronic program table information and program related information to output an electronic program table being attached with the program related information.

2. The apparatus of claim 1, wherein the program related information includes a user comment.

3. The apparatus of claim 1, wherein the output instructing module is configured to instruct the server to output the program related information.

4. The apparatus of claim 1 further comprising:
a display module configured to display the output electronic program table attached with the program related information.

5. The apparatus of claim 1, wherein a desired program is designated from the output electronic program table attached with the program related information.

6. The apparatus of claim 1, wherein the program related information is distinctively output to the electronic program table.

7. The apparatus of claim 1, wherein the electronic apparatus is configured to output second display indicating the program related information.

8. A control method of an electronic apparatus, comprising:
instructing a server, stored therein electronic program table information, to output the electronic program table information;
receiving the electronic program table information and program related information output from the server; and
outputting an electronic program table being attached with the program related information using the received electronic program table information and program related information.

9. A non-transitory computer-readable recording medium storing a computer executable control program of an electronic apparatus that, when executed causes a computer to perform a control method comprising:
instructing a server, stored therein electronic program table information, to output the electronic program table information;
receiving the electronic program table information and program related information output from the server; and
outputting an electronic program table being attached with the program related information using the received electronic program table information and program related information.
